(19) United States
(12) Patent Application Publication
(10) Pub. No.: US 2021/0009324 A1
(43) Pub. Date: Jan. 14, 2021

(54) Magnifying Product Packaging and Display with Child Resistant Opening Mechanism

(71) Applicant: Al Stein, Inc., Commerce, CA (US)

(72) Inventor: Francesco DiGrado, Commerce, CA (US)

(21) Appl. No.: 16/923,638

(22) Filed: Jul. 8, 2020

Related U.S. Application Data
(60) Provisional application No. 62/871,525, filed on Jul. 8, 2019.

(51) Int. Cl. B65D 50/06; B65D 51/24; A61J 1/03

(52) U.S. Cl. CPC B65D 50/061; A61J 1/03; B65D 51/24

(57) ABSTRACT

A product packaging container for containing and displaying a product. The container includes a lid and a container portion. The lid has a lid rim and lid outer side having a semi-spherical lid outer surface. The lid is formed of a translucent material and the lid is optically magnifying with respect to light passing through the lid. The container portion having a container portion inner side and defining a container longitudinal axis. The container portion inner side being defined by a container portion rim. The container portion has a product cavity. The lid is only able to move along the longitudinal axis from an engaged configuration to a separated configuration upon the lid being rotationally aligned with the container portion at a predetermined position about the longitudinal axis, and the container portion being flexed in plastic deformation in response to a lateral compressive force radially inward toward the longitudinal axis.

### CROSS-REFERENCE TO RELATED APPLICATIONS

The present application claims priority to U.S. Patent Application Ser. No. 62/871,525, filed Jul. 8, 2019, the entire contents of which are incorporated herein by reference.

### STATEMENT RE: FEDERALLY SPONSORED RESEARCH/DEVELOPMENT

Not Applicable

### BACKGROUND

The present invention relates generally to product packaging containers, and more specifically, to a product packaging container having a magnifying lid and container portion with a child resistant opening mechanism.

Child resistant closures for containers are very important for the safety of children. Child resistant closures are also referred to as child-resistant closures, CR closures, child-proof packaging or opening mechanisms. Child resistant closures refers generally to the inability of a younger child's or person with a younger child's strength and/or manual dexterity to open a closure a given percentage (such as 85%) of the time within a given amount of time without a demonstration of how to open the closure, or a less percentage (such as 80%) of the time with such a demonstration. Such percentages and timing may be according to various applicable regulations or industry guidelines.

There are a wide variety of child resistant closures. The typical application is in the context of medicine packaging containers, that include a cap and pill container or bottle. The cap designs are such that cap may be only removed in a very specific manner. These cap designs tend to work well because children lack the strength, cognitive ability, dexterity and/or motor skills to make the required motions simultaneously. Dual motion closures have proven to be not readily openable by children, and therefore effectively achieve the goal of preventing children from opening the container on which the container is attached to prevent unwanted access to the products contained inside the container. However, given the safety related background of the child-resistant closures, aesthetics of the overall child resistant packaging is of minimal concern.

Accordingly, there is a need in the art for an improved product packaging container. Various aspects of the present invention address this particular need, as will be discussed in more detail below.

### BRIEF SUMMARY

In accordance with one embodiment of the present invention, there is provided a product packaging container for containing and displaying a product. The product packaging container includes a lid and a container portion. The lid has a lid outer side and a lid inner side. The lid outer side has a semi-spherical lid outer surface. The lid inner side is defined by a lid rim. The lid is formed of a translucent material. The lid is optically magnifying with respect to light passing through the lid. The container portion has a container portion outer side and a container portion inner side and defines a container longitudinal axis. The container portion inner side is defined by a container portion rim. The container portion further has a product cavity extending from the container portion rim into the container portion for containing the product therein. The lid and the container portion have an engaged configuration and a separated configuration. In the separated configuration the lid and the container portion are completely separated from each other. In the engaged configuration the lid and the container portion are sized and configured to cooperatively engage each other with the lid rim disposed adjacent container portion rim. In the engaged configuration the lid is able to freely rotate relative to the container portion about the container longitudinal axis. The lid is only able to move along the container longitudinal axis from the engaged configuration to the separated configuration upon the lid being rotationally aligned with the container portion at a predetermined position about the container longitudinal axis, and the container portion being flexed in plastic deformation in response to a lateral compressive force radially inward toward the longitudinal axis.

According to various embodiments, the lid may only be able to move along the longitudinal axis from the engaged configuration to the separated configuration upon the container portion being flexed in plastic deformation in response to lateral opposing compressive forces radially inward toward the container longitudinal axis, and the lid rim separates from being adjacent container portion rim at a circumferential location about the container portion rim between where the lateral opposing compressive forces are applied. The lid may include retaining tabs extending radially inward adjacent the lid rim, and the container portion may include an inner lip extending radially outward adjacent the container portion rim. In the engaged configuration the retaining tabs are disposed longitudinally between the inner lip and the product cavity. The inner lip may include guide notches and each of the guide notches are sized and configured to correspond to a specific one of the retaining tabs. The circumferential location corresponds to a retaining tab and a corresponding guide notch.

In another embodiment, the lid may include retaining tabs extending radially inward adjacent the lid rim, and the container portion may include an inner lip extending radially outward adjacent the container portion rim. In the engaged configuration the retaining tabs are disposed longitudinally between the inner lip and the product cavity. The inner lip may include guide notches with each of the guide notches being sized and configured to correspond to a specific one of the retaining tabs. The retaining tabs may be aligned with each of the corresponding guide notches upon the lid being rotationally aligned with the container portion at the predetermined position about the longitudinal axis during the lid being able to move along the longitudinal axis from the engaged configuration to the separated configuration. The retaining tabs may not be the same size.

In addition, the lid may be formed of a material having a relatively high refractive index. In the engaged configuration, viewing of the product in the product cavity is magnified when viewed through the lid. The container portion may be formed of an elastomeric material in comparison the lid. The lid may be formed of a relatively more rigid material in comparison the container portion. The lid may include an outer shell, and the lid outer surface is disposed about the outer shell. The lid may further include a magnifying body disposed within the outer shell. The magnifying body may be formed of a material having a relatively high refractive index. The container portion outer side may be semi-spherical shaped. In the engaged configuration, the product packaging container is spherical shaped.

Further, the product packaging container may further include a seal member. The seal member has a seal member body, and the seal member is sized and configured to engage the container portion with the seal member body spanning from adjacent the container portion rim to enclose the product cavity. The seal member may further include a sealing ring extending orthogonal to the seal member body. The container portion may include an outer sealing wall. The outer sealing wall is circular and extends from adjacent the container portion rim parallel to the container longitudinal axis, and the sealing ring is sized and configured to be concentrically positionable within the outer sealing wall.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, in which:

FIG. 1 is a top perspective view of a product packaging container with a lid and a container portion in an engaged configuration according to an aspect of the present invention;

FIG. 2 is a bottom perspective view of the product packaging container of FIG. 1;

FIG. 3 is a perspective view of the product packaging container with the lid and the container portion in a separated configuration;

FIG. 4 is an exploded perspective view of the container portion of FIG. 3 with a seal member;

FIG. 5 is an exploded cross-sectional side view of the product packaging container;

FIG. 6 is a cross-sectional side view of the product packaging container in an engaged configuration and containing product in dashed lining;

FIG. 7 is an enlarged cross-sectional view along axes 7-7 of FIGS. 3 and 6 of a portion of the product packaging container with the lid in the engaged configuration;

FIG. 8 is an enlarged cross-sectional view along axes 8-8 of FIGS. 3 and 6 of a portion of the product packaging container with a force F applied and the container portion being flexing in plastic deformation with the lid in the engaged configuration; and

FIG. 9 is an enlarged cross-sectional view along axis 9-9 of FIG. 3 of a portion of the product packaging container with the lid being moved upward from the engaged portion.

Common reference numerals are used throughout the drawings and the detailed description to indicate the same elements.

### DETAILED DESCRIPTION

The detailed description set forth below in connection with the appended drawings is intended as a description of certain embodiments of product packaging and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

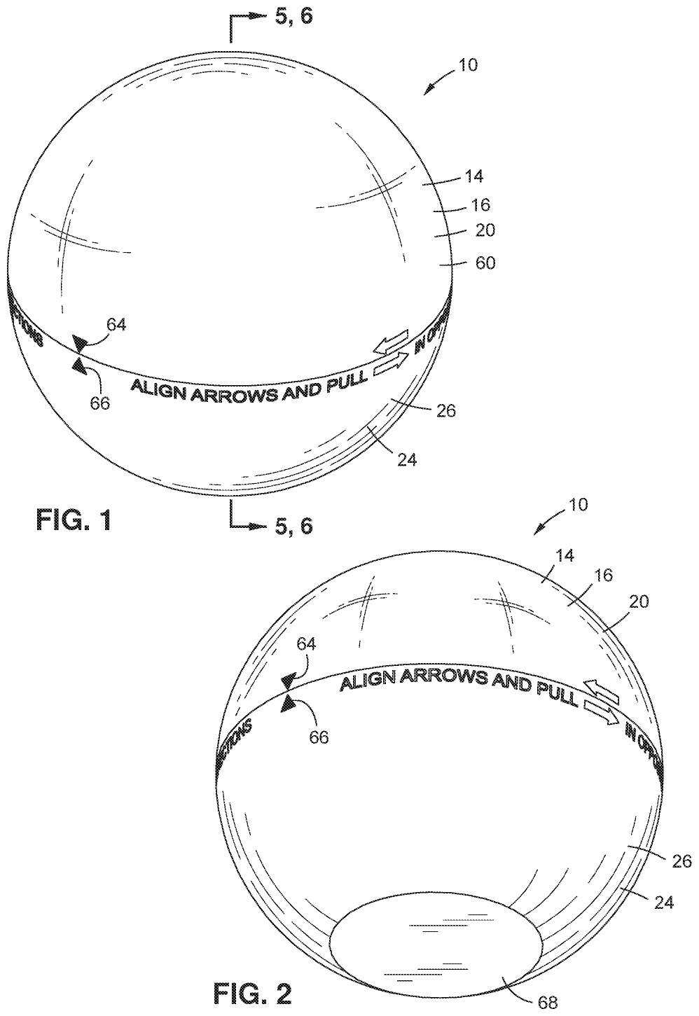

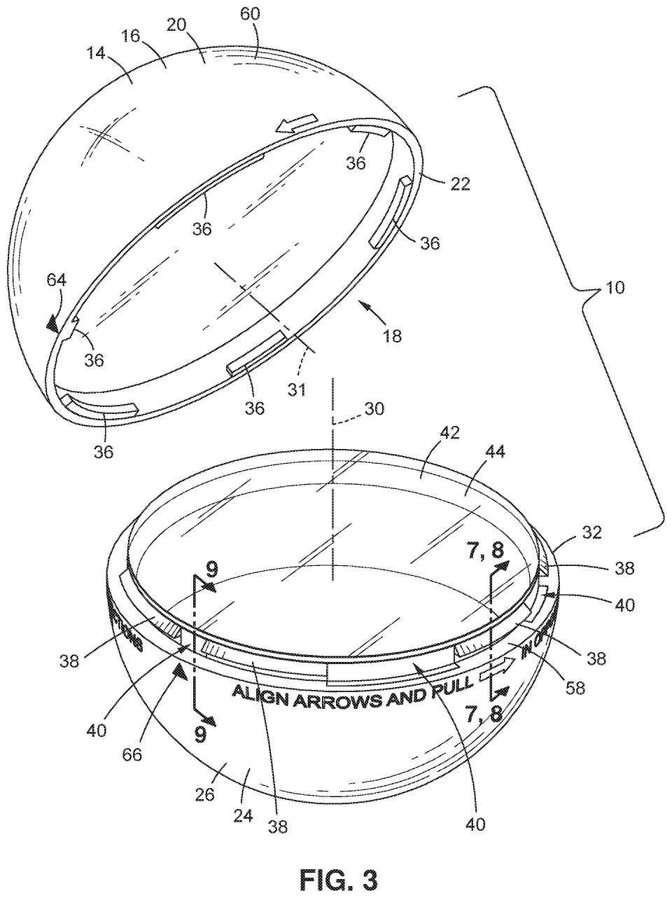

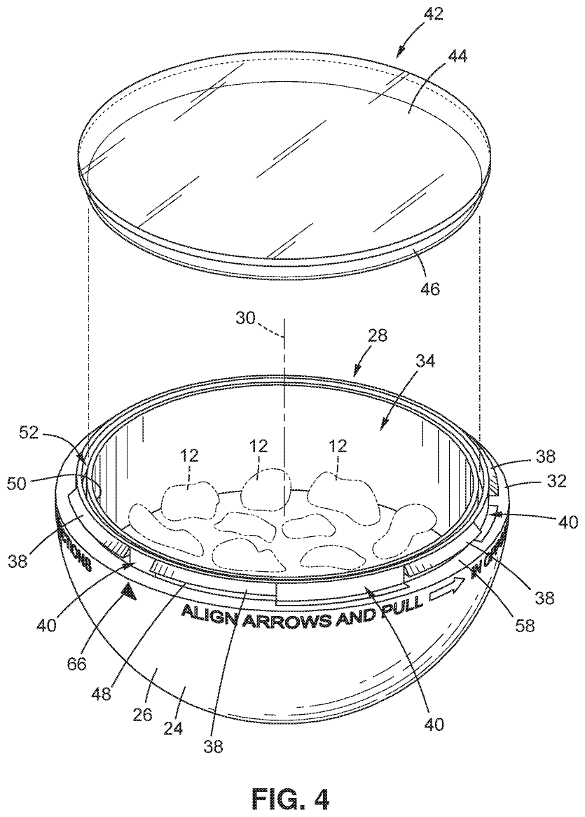

Referring now to the drawings, wherein the showings are for purposes of illustrating a preferred embodiment of the present invention, and not for purposes of limiting the same, there is depicted a product packaging container 10 for containing and displaying a product 12 (such as symbolically depicted in dashed lining in FIGS. 4 and 6). FIG. 1 is a top perspective view of the product packaging container 10 with a lid 14 and a container portion 24 in an engaged configuration according to an aspect of the present invention. FIG. 2 is a bottom perspective view of the product packaging container 10 of FIG. 1. FIG. 3 is a perspective view of the product packaging container 10 with the lid 14 and the container portion 24 in a separated configuration.

The product packaging container 10 includes the lid 14 and the container portion 24. The lid 14 has a lid outer side 16 and a lid inner side 18. The lid outer side 16 has a semi-spherical lid outer surface 20. The lid inner side 18 is defined by a lid rim 22. The lid 14 is formed of a translucent material. The lid 14 is optically magnifying with respect to light passing through the lid 14. The container portion 26 has a container portion outer side 26 and a container portion inner side 28 and defines a container longitudinal axis 30. The lid may have a lid longitudinal axis 31. The container portion inner side 28 is defined by a container portion rim 32. The container portion 24 further has a product cavity 34 extending from the container portion rim 32 into the container portion 24 for containing the product 12 therein. The lid 14 and the container portion 24 have an engaged configuration and a separated configuration. In the separated configuration the lid 14 and the container portion 24 are completely separated from each other, such as depicted in FIG. 3. In the engaged configuration the lid 14 and the container portion 24 are sized and configured to cooperatively engage each other with the lid rim 22 disposed adjacent container portion rim 32. In the engaged configuration the lid 14 is able to freely rotate relative to the container portion 24 about the container longitudinal axis 30. The lid 14 is only able to move along the container longitudinal 30 axis from the engaged configuration to the separated configuration upon the lid 14 being rotationally aligned with the container portion 24 at a predetermined position about the container longitudinal axis 30, and the container portion 24 being flexed in plastic deformation in response to a lateral compressive force radially inward toward the container longitudinal axis 30.

It is contemplated that the above-described product packaging design is particularly useful for allowing a user to view products 12 within the product packaging container 10 in which the products are magnified. This allows for the user to inspect the products without having to actually touch or otherwise remove the products 12 its packaging. This is avoids inadvertent potential contamination and damage to the products and also avoids direct exposure to the user where the product may me harmful to the user. Moreover, because of the magnification, the above-described product packaging design is particularly useful for displaying the products 12 for users or observers. The above-described product packaging design may be used to contain any products 12. For example, the products 12 may be precious items or collectables, such as stamps, coins, relics, jewelry, memorabilia, etc. Other items may include such goods as herbs, cannabis flower, confectionary treats, and medications.

It may be desirable for a seller of the products 12 to be able to display the products 12 for possible purchase by potential customers. In this regard, it is contemplated the magnifying semi-spherical shape of the lid 14 is a particularly aesthetically pleasing design. So much so, purchasers or acquirers of the products 12 contained in the product packaging container 10 may likely keep, display, preserve, protect, and store the products 12 in such the product packaging container 10. This is unlike typical product packaging designs may be simply contain a product for the user to initially acquire a product and for later transfer to a more permanent storage solution. Moreover, the product packaging container 10 is contemplated to implement as child resistant opening mechanism that requires dual simultaneous motions with regards to the container longitudinal axis 30. Such design is contemplated to be particularly useful to protect against inadvertent access to the products 12 by children. In this regard, in an embodiment, after aligning the lid 14 and the container portion 24, the lid may be only removed by applying a compressive force inward towards the container longitudinal axis 30 while also applying a force along the container longitudinal axis 30 to the lid 14 away from the container portion 24.

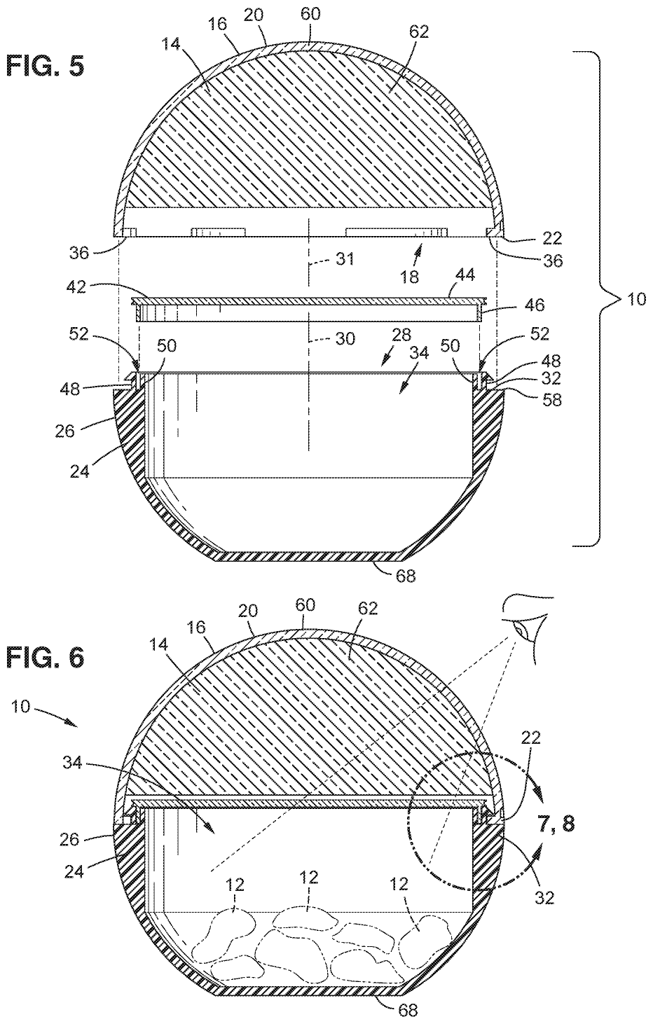

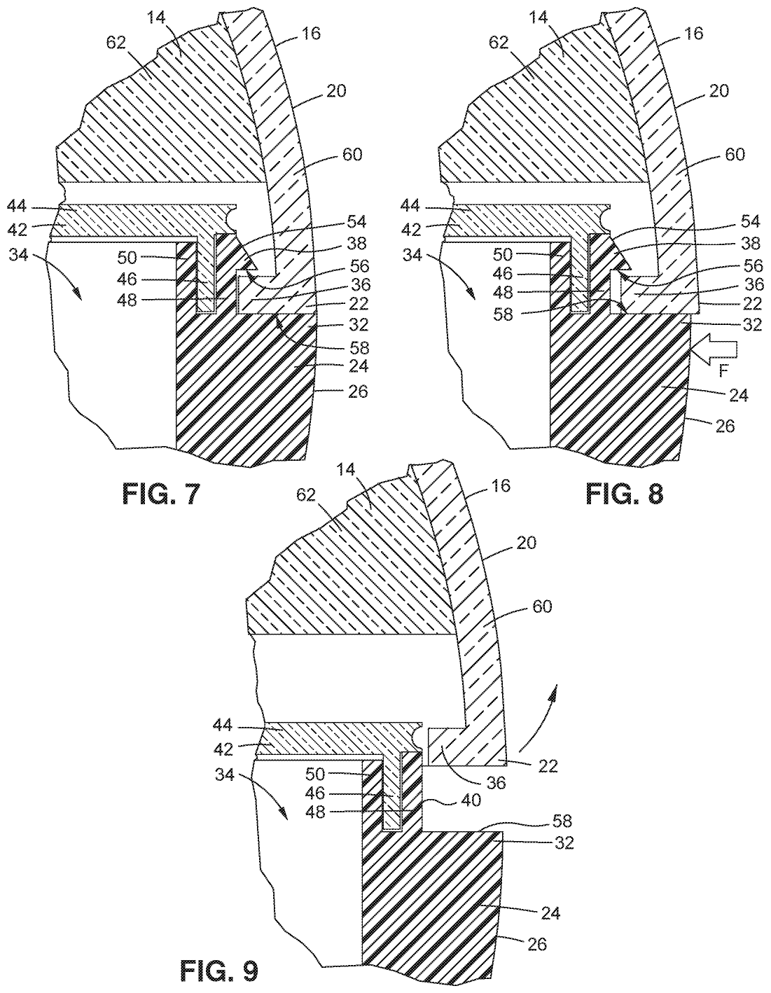

Referring additionally to FIG. 4, there is depicted an exploded perspective view of the container portion 24 of FIG. 3 with a seal member 42. FIG. 5 is an exploded cross-sectional side view of the product packaging container 10. FIG. 6 is a cross-sectional side view of the product packaging container 10 in an engaged configuration and containing the product 12 in dashed lining. FIG. 7 is an enlarged cross-sectional view along axes 7-7 of FIGS. 3 and 6 of a portion of the product packaging container 10 with the lid 14 in the engaged configuration. FIG. 8 is an enlarged cross-sectional view along axes 8-8 of FIGS. 3 and 6 of a portion of the product packaging container with a force F applied and the container portion 24 being flexing in plastic deformation with the lid 14 in the engaged configuration. FIG. 9 is an enlarged cross-sectional view along axis 9-9 of FIG. 3 of a portion of the product packaging container 10 with the lid 14 being moved upward from the engaged portion.

According to various embodiments, the lid 14 may include retaining tabs 36 extending radially inward adjacent the lid rim 22, and the container portion 24 may include an inner lip 38 extending radially outward adjacent the container portion rim 32. In the engaged configuration the retaining tabs 36 are disposed longitudinally between the inner lip 38 and the product cavity 34, such as depicted in FIGS. 6 and 7. The inner lip 38 may include guide notches 40 and each of the guide notches 40 are sized and configured to correspond to a specific one of the retaining tabs 36. The circumferential location corresponds to a retaining tab 36 and a corresponding guide notch 40.

The lid 14 may include a first alignment indicia 64, and the container portion 24 may include a second alignment indicia 66. In FIGS. 1 and 2, the first and second alignment indicia 64, 66 are depicted as being positioned immediately adjacent one another. As best viewed, the first alignment indicia 64 is positioned angularly adjacent a retaining tab 64, and the corresponding guide notch 40 is positioned angularly adjacent the second alignment indicia 66.

The retaining tabs 36 may be aligned with each of the corresponding guide notches 40 upon the lid 14 being rotationally aligned with the container portion 24 at the predetermined position about the container longitudinal axis 30 during the lid 14 being able to move along the container longitudinal axis 30 from the engaged configuration to the separated configuration. The first and second alignment indicia 64, 66 may be used to indicate to the user how to angularly orient the lid 14 with respect to the container portion 24 for the lid 14 to be in such predetermined position.

The sizing of the guide notches 40 are specific to the corresponding ones of the retaining tabs 36 such that a given guide notch 40 is just circumferentially wide enough to allow the corresponding retainer tab 36 to pass while the lid 14 is moved between the engaged and separated configurations. At same time the guide notches 40 are contemplated to not be overly wide and only enough to allow its corresponding retainer tab 36 to pass. In this respect, the retaining tabs 36 may not be the same size. In this regard, as depicted in FIG. 3, the retaining tab 36 disposed adjacent the first alignment indicia 64 is the smallest one in comparison to the other retaining tabs 36. For example, the guide notch 40 adjacent the first alignment indicia 64 is just wide enough to allow the retaining tab 36 that is adjacent the second alignment indicia 66 (the narrowest) while also being too narrow to allow any of the other retaining tabs 36 to pass. As such, once the lid 14 and the container portion 24 are in the engaged configuration, the lid 14 may only be removed with the retaining tabs 36 being positioned adjacent their corresponding and complementary guide notches 40.

According to various embodiments, the lid 14 may only be able to move along the container longitudinal axis 30 from the engaged configuration to the separated configuration upon the container portion 24 being flexed in plastic deformation in response to lateral opposing compressive forces radially inward toward the container longitudinal axis 30, and the lid rim 20 separates from being adjacent container portion rim 32 at a circumferential location about the container portion rim 32 between where the lateral opposing compressive forces are applied. In this regard, the point of separation may be at 90 degrees from where each of the lateral opposing compressive forces are being applied with respect to the circumferential location about the container portion 32.

As mentioned above, the lid 14 is only able to move along the container longitudinal 30 axis from the engaged configuration to the separated configuration upon the lid 14 being rotationally aligned with the container portion 24 at a predetermined position about the container longitudinal axis 30.

Referring to the enlarged cross-sectional view of FIG. 7, the lid 14 and the container portion 24 are in the engaged configuration. FIG. 8 is the same view of the lid 14 and the container portion 24 of FIG. 7, however, with a force F applied and the container portion 24 being flexing in plastic deformation. The container portion rim 32 is depicted as being slightly moved towards the left in response to the force F being applied. Another compressive force may be applied to the opposite side of the container portion 24. Such complementary compressive forces are contemplated to result the container portion 24 undergoing a temporary change in shape with the container portion rim 32 flexing from the completely round shape to an ever so slight oval shape. Such change in shape results in a slight mismatch of the adjacent lid rim 22 which is not undergoing such change in shape. It is contemplated that in the engaged configuration the lid rim 22 and the container portion rim 32 may be directly interfacing with each other. Such interface may even result is a slight suction force maintained between them. The flexing of the container portion 24 is contemplated to momentarily break any such suction or sealing action at such interface to allow the lid 14 to break free.

In the example depicted, the point of separation may be at 90 degrees from where each of the lateral opposing compressive forces are being applied with respect to the circumferential location about the container portion 32. This corresponding a point of initial point of separation of the lid 14 from the container portion 24 being located adjacent the first and second alignment indicia and the adjacent retaining tab 36 and guide notch 40 as depicted in FIG. 9. From this positioning a force may be applied to pivot the lid 14 to open and separate the lid 14 away from the container portion 24 from such point of separation. Such pivoting includes a component motion of the lid 14 along the container longitudinal axis 30, in much the same motion as cracking open an egg in half. Moreover, it is contemplated that the pivoting may include a component of motion lateral to the container longitudinal axis 30 resulting in a lateral sheer force between the lid 14 and the container portion 24. The overall forces involved may be otherwise characterized as the user having to both squeeze and pull in order to separate the lid from the container portion. Such dual movements are contemplated to challenge the cognitive and dexterity abilities of a child. Further adding to the cognitive challenge of opening the product packaging container 10 is the requirement of the lid 14 being initially properly aligned with the container portion 24 as discussed above.

As mentioned above, the lid 14 is formed of a translucent material. In this regard, a user may view product 12 disposed within the product cavity 34 by looking through the lid 14. The translucent material may be clear or include a tint or coloring. The lid 14 is optically magnifying with respect to light passing through the lid 14. As one of ordinary skill in the art will recognize the particular semi-spherical shape of the lid outer surface 20 may allow the lid 14 to form a magnifying lens.

In the engaged configuration, viewing of the product in the product cavity is magnified when viewed through the lid. The lid 14 is formed of a material having a relatively high refractive index. Such material may be chosen from those which are well known to one of ordinary skill in the art with characteristics the result in a desired magnification, and may include various plastics, such as a polycarbonate or acrylic material. It is contemplated that the container portion 24 may be formed of an elastomeric material in comparison the lid 14. In this regard, the lid 14 may be formed of a relatively more rigid material in comparison the container portion 24. The container portions 24 may be formed of a plastic as may be chosen from those which are well known in the art that features the desired plastic deformation characteristics in relation to normal formals as may be manually applied by a user. The container portion 24 is contemplated to be formed of a material which is translucent or opaque.

The lid 14 may include an outer shell 60, and the lid outer surface 20 is disposed about the outer shell 60. The lid 14 may further include a magnifying body 62 disposed within the outer shell 60. The magnifying body 62 may be formed of a material having a relatively high refractive index and may be different from that of the outer shell 60.

The container portion outer side 26 may be semi-spherical. In the engaged configuration, the product packaging container 10 is spherical shaped. The container portion 24 may include a base 68. The base 68 may take the form of a flattened region along the container portion outer side 26 generally opposite the container portion rim 32. The product packaging container 10 may be positioned on a flat surface, such as a table top, as supported by the base 68. The base 68 need not be exactly opposite the container portion rim 32 to as to allow for an ease of magnified viewing from a raised lateral viewing position.

Further, the product packaging container may further include a seal member 42. The seal member 42 has a seal member body 44, and the seal member 42 is sized and configured to engage the container portion 10 with the seal member body 44 spanning from adjacent the container portion rim 32 to enclose the product cavity 34. The seal member body 44 may be a translucent material, and may be formed of a clear plastic material. The seal member 42 may further include a sealing ring 46 extending orthogonal to the seal member body 44. The container portion 24 may include an outer sealing wall 48. The outer sealing wall 48 is circular and extends from adjacent the container portion rim 32 parallel to the container longitudinal axis 32. The inner lip 38 may radially project from the outer sealing wall 48. The sealing ring 46 is sized and configured to be concentrically positionable within the outer sealing wall 48. The container portion 24 may further include an inner sealing wall 50 concentrically disposed within the outer sealing wall 48. A sealing groove 52 is formed between the outer sealing wall 48 and the inner sealing wall 50. The sealing ring 46 is sized and configured to be concentrically positionable within the sealing groove 52 and about the inner sealing wall 50. With this configuration, upon the lid 14 and the container portion 24 being in the separated configuration, the seal member 42 may act to further contain the products 12 within the product cavity 34.

The inner lip 38 may radially project from the outer sealing wall 48. The inner lip 38 may include a chamfered outer surface 54 that is facing radially and away from the product cavity 34. The chamfered outer surface 54 is contemplated to allow the lid 14 is be readily indexed against the container portion 24 upon the lid 14 being centered about the container portion 24 for closure. The inner lip 38 may further include an under surface 56. The container portion rim 32 includes an outer ledge 58. The outer sealing wall 48 extends from the outer ledge 58. It is contemplated that the retaining tabs 36 are captured between the under surface 56 of the inner lip 38 and the outer ledge 58 with the lid 14 and the container portion 24 in the engaged position.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A product packaging container for containing and displaying a product, the product packaging container comprising:
a lid having a lid outer side and a lid inner side, the lid outer side having a semi-spherical lid outer surface, the lid inner side being defined by a lid rim, the lid being formed of a translucent material, the lid being optically magnifying with respect to light passing through the lid; and
a container portion having a container portion outer side and a container portion inner side and defining a container longitudinal axis, the container portion inner side being defined by a container portion rim, the container portion further having a product cavity extending from the container portion rim into the container portion for containing the product therein;
wherein the lid and the container portion have an engaged configuration and a separated configuration, in the separated configuration the lid and the container portion are completely separated from each other, in the engaged configuration the lid and the container portion are sized and configured to cooperatively engage each other with the lid rim disposed adjacent container portion rim, in the engaged configuration the lid is able to freely rotate relative to the container portion about the container longitudinal axis; and
wherein the lid is only able to move along the container longitudinal axis from the engaged configuration to the separated configuration upon the lid being rotationally aligned with the container portion at a predetermined position about the container longitudinal axis, and the container portion being flexed in plastic deformation in response to a lateral compressive force radially inward toward the container longitudinal axis.

2. The product packaging container of claim 1 wherein the lid is only able to move along the container longitudinal axis from the engaged configuration to the separated configuration upon the container portion being flexed in plastic deformation in response to lateral opposing compressive forces radially inward toward the container longitudinal axis, and the lid rim separates from being adjacent container portion rim at a circumferential location about the container portion rim between where the lateral opposing compressive forces are applied.

3. The product packaging container of claim 2 wherein the lid includes retaining tabs extending radially inward adjacent the lid rim, the container portion includes an inner lip extending radially outward adjacent the container portion rim, in the engaged configuration the retaining tabs are disposed longitudinally between the inner lip and the product cavity.

4. The product packaging container of claim 3 wherein the inner lip includes guide notches, each of the guide notches are sized and configured to correspond to a specific one of the retaining tabs.

5. The product packaging container of claim 4 wherein the circumferential location corresponds to a retaining tab and a corresponding guide notch.

6. The product packaging container of claim 1 wherein the lid includes retaining tabs extending radially inward adjacent the lid rim, the container portion includes an inner lip extending radially outward adjacent the container portion rim, in the engaged configuration the retaining tabs are disposed longitudinally between the inner lip and the product cavity.

7. The product packaging container of claim 6 wherein the inner lip includes guide notches, each of the guide notches are sized and configured to correspond to a specific one of the retaining tabs.

8. The product packaging container of claim 7 wherein the retaining tabs are aligned with each of the corresponding guide notches upon the lid being rotationally aligned with the container portion at the predetermined position about the longitudinal axis while the lid being able to move along the longitudinal axis from the engaged configuration to the separated configuration.

9. The product packaging container of claim 6 wherein the retaining tabs are not the same size.

10. The product packaging container of claim 1 wherein the lid is formed of a material having a relatively high refractive index.

11. The product packaging container of claim 1 wherein in the engaged configuration, viewing of the product in the product cavity is magnified when viewed through the lid.

12. The product packaging container of claim 1 wherein the container portion is formed of an elastomeric material in comparison the lid.

13. The product packaging container of claim 1 wherein the lid is formed of a relatively more rigid material in comparison the container portion.

14. The product packaging container of claim 1 wherein the lid includes an outer shell, the lid outer surface is disposed about the outer shell.

15. The product packaging container of claim 14 wherein the lid further includes a magnifying body disposed within the outer shell.

16. The product packaging container of claim 15 wherein the magnifying body is formed of a material having a relatively high refractive index.

17. The product packaging container of claim 1 wherein the container portion outer side is a semi-spherical shaped.

18. The product packaging container of claim 1 wherein in the engaged configuration, the product packaging container is spherical shaped.

19. The product packaging container of claim 1 further includes a seal member, the seal member has a seal member body, the seal member is sized and configured to engage the container portion with the seal member body spanning from adjacent the container portion rim to enclose the product cavity.

20. The product packaging container of claim 19 wherein the seal member further includes a sealing ring extending orthogonal to the seal member body, the container portion includes an outer sealing wall, the outer sealing wall is circular and extends from adjacent the container portion rim parallel to the container longitudinal axis, the sealing ring is sized and configured to be concentrically positionable within the outer sealing wall.
